(19) United States
(12) Patent Application Publication
(10) Pub. No.: US 2005/0198663 A1
(43) Pub. Date: Sep. 8, 2005

(54) User interface method and system for navigation in networked devices

(75) Inventors: John William Chaney, Gilroy, CA (US); Changki Lee, Sunnyvale, CA (US)

Correspondence Address: MYERS DAWES ANDRAS & SHERMAN, LLP, 19900 MACARTHUR BLVD.,, SUITE 1150, IRVINE, CA, 92612, US

(73) Assignee: Samsung Electronics Co., Ltd., Suwon City (KR)

(21) Appl. No.: 11/005,941

(22) Filed: Dec. 7, 2004

Related U.S. Application Data
(60) Provisional application No. 60/530,501, filed on Dec. 18, 2003.

(51) Int. Cl. G06F 13/00; H04N 5/445

(52) U.S. Cl. 725/38

(57) ABSTRACT

A method and system of browser-based command and control for devices in a network of client devices (e.g., controller devices) and service devices (e.g., controlled devices). The client devices allow the user to control the server devices. To reduce user programming of client device to control the server devices, a web browser is included in each client device and a web server is included in each service device that provides a service to be controlled by a client device. The user's navigational context is tracked as the user navigates around from device to device in the network. This provides information for the context of the web server for each service device, to reduce the need for the user to program that information into the client device.

### CROSS-REFERENCE TO RELATED APPLICATION

Priority is claimed from U.S. Provisional Application No. 60/530,501, filed on Dec. 18, 2003, which is incorporated herein by reference.

### FIELD OF THE INVENTION

The present invention relates to user interfaces for networked devise, and particular to user interfaces for navigation of network devices using World Wide Web protocols.

### BACKGROUND OF THE INVENTION

A network generally includes a communication link and various devices with communication capability connected to the communication link. The devices include computers, peripheral devices, routers, storage devices, consumer electronics and appliances with processors and communication interfaces. An example of a network is a home network for a household in which various devices are interconnected. A usual household can contain several devices including personal computers and home devices such as consumer electronics and appliances that are typically found in the home. As such the term “device” generally includes logical devices or other units having functionality and an ability to exchange data, and can include not only all home devices but also general purpose computers. Home devices include such electronic devices as security systems, theater equipment, consumer electronics (e.g., TVS, VCRs, DVD players, stereo equipment, direct broadcast satellite services (DBSS), digital satellite services (DSS), etc.), sprinkler systems, lighting systems, appliances (e.g., microwave, dish washer, ovens/stoves, washers/dryers), a processing system in an automobile, etc.

Consumer electronics, such as home theater equipment, are often controlled using a controller device (e.g., remote control device). However, a drawback associated with using such a controller device to control home devices is that each particular controller device must be specifically programmed to control and command those home devices for which it is intended. This requires the user to program, or to load software into, the controller device to control various devices.

There is, therefore, a need for a method and system that provides a user interface in controller devices for controlling other devices, which reduces the need for a user to program the controller devices.

### BRIEF SUMMARY OF THE INVENTION

The present invention addresses the above needs. In one embodiment the present invention provides a method for providing a user interface in a network including interconnected client and service devices, the user interface for controlling the service devices that are currently connected to the network, comprising the steps of: obtaining information from one or more of said service devices currently connected to the network, said information including device information; generating a user interface including status information of said service devices based on said device information; displaying the user interface on a client device capable of displaying a user interface, for user navigation and control of said service devices; tracking user navigation and control of said service devices; and based on the tracking information, providing the user with default service device selection on the user interface.

The step of providing the user with default service device selection can further be based on the service device function and based on one of prior service device selections by the user. The service devices can include source devices and sink devices, such that the step of providing the user with a default sink device selection for a source device can further be based on one of prior sink device selections by the user. Further, the step of providing the user with a default source device selection for a sink device can further be based on one of prior source device selections by the user.

Displaying the user interface on said client device can further include the steps of displaying the user interface on a browser in the client device. The user interface can further display device control information as a service device is selected by the user. The device information in each service device includes a user interface description for user interaction with that device.

In another embodiment the present invention provides a controller in the client device in a network that provides the user interface according to the above steps. Yet, in another embodiment the present provides a network of interconnected client and service devices that implement the above steps.

As such, in one example implementation the present invention provides a method and system of browser-based command and control for devices in a network comprising client devices (e.g., controller devices) and service devices (e.g., controlled devices). The client devices allow the user to control the server devices. To reduce user programming of client device to control the server devices, a web browser is included in each client device and a web server is included in each service device that provides a service to be controlled by a client device. The user's navigational context is tracked as the user navigates around from device to device in the network. This provides information for the context of the web server for each service device, to reduce the need for the user to program that information into the client device.

Other embodiments, features and advantages of the present invention will be apparent from the following specification taken in conjunction with the following drawings.

### BRIEF DESCRIPTION OF THE DRAWINGS

FIG. 1A shows an example functional block diagram of a network implementing a user interface system according to an embodiment of the present invention;

FIG. 1B shows an example functional block diagram of another network implementing a user interface system according to an embodiment of the present invention;

FIG. 1C shows an example user interface for user navigation and control in the network of FIG. 1B according to an embodiment of the present invention;

FIG. 1D shows a control device for user entry of commands;

FIGS. 2-9 shows example user interfaces including representations of the discovered devices in the network in status and control frames based on user navigation and control, according to embodiments of the present invention; and

FIG. 10 shows example condition control device keys for controlling the devices in the network according to another embodiment of the present invention.

### DETAILED DESCRIPTION OF THE INVENTION

In one embodiment, the present invention provides a method and system of browser-based command and control for devices in a network comprising client devices (e.g., controller devices) and service devices (e.g., controlled devices). The client devices allow the user to control the server devices. To reduce user programming of client device to control the server devices, a web browser is included in each client device and a web server is included in each service device that provides a service to be controlled by a client device. The user's navigational context is tracked as the user navigates around from device to device in the network. This provides information for the context of the web server for each service device, to reduce the need for the user to program that information into the client device.

Conventionally, connecting across a network with web browsers and web servers without programmatic control therebetween, when a service device is visited by the user via the browser of a client device, the context of the user's visit is not utilized for predicting the user's future preferences. For example, if the network includes a tuner (source device) and two televisions (sink devices), when the user selects a station to play from the tuner, though the tuner becomes a source for video and audio, a sink device is not automatically selected for the user. This requires the user to select one of the sink devices as the sink device for the selected source device. Even if the user has previously visited/selected one of the sink devices, conventional system require the user to select a sink device using the browser of the client device, each time the user selects a source device.

In one embodiment, the present invention keeps track of the user's navigational context and selections, as the user navigates from service device to service device in the network. The information about the context of the web server for each service device visited by the user is provided to the browser of the client device that the user is utilizing to control the service devices. This virtually eliminating the need for the user to provide that information to the client device for controlling the service devices.

In one example, when the network is first powered on, a discovery process is performed to determine the connected physical devices and logical units/devices. Then, the representations for the discovered devices appear on the web browser of a client device to receive user control commands, an initial default context for the networked devices is shown to the user. As the user navigates to, and selects, a sink device using the web browser of the client device, the client device keeps track of that last sink device that the user selected (the controller records the name of the last user selected sink device). Then, when the user selects a source device, the client device provides the user's prior selection of the sink device to that source device, without asking the user to specify a sink device for that source device. As such, the source device connects, and sends information, to the sink device specified by the last user-visited link in the browser of the client device. The last visited sink device becomes the default sink device for the source devices selected thereafter, until the user changes that by navigating to another sink device. The user navigation context is tracked, maintained, in one example, by using global variables in a Javascript to retain the name and associated identifiers and properties of the last device that the user selected.

An example implementation of a method and system according to the present invention is now described in the context of a home network implementing the 1394 protocol. However, as those skilled in the art will recognize, the present invention is useful with other types of networks using different network protocols. Further, thought the example herein utilizes web browser client server methodology (extended to TCP/IP networks in general), those skilled in the art will recognize that other client server protocols may also be used. A Web browser (browser) is used in this description as an example graphical presentation engine network resource, and other graphical presentation engines can also be used.

Further, the following abbreviations are used in this description: ATSC—Advanced Television Systems Committee; AV—Audio/video; AV/C—Audio/video control; DHCP—Dynamic host configuration protocol; DNS—Domain name server; DTV—Digital Television; HDTV—High Definition Television; GIF—Graphics interchange format; GUI—Graphical user interface; HNCP—Home network configuration protocol; XML—Extensible Markup Language; XHTML—XML compliant Hypertext markup language; HTTP—Hypertext transfer protocol; OSD—Onscreen display; and STB—Set top box.

A user interface system according to the example embodiment of the present invention allows a service device to utilize the presentation capabilities in a network-attached client device that includes a renderer, to present status and control interface of the service device to a user. The service device can comprise, e.g., a source of home-network content services such as a cable or terrestrial set-top box, digital VCR, DTV, etc. Further, the renderer can comprise a device that has access to a display for presenting the control interface of the source to the user in a graphical user interface (GUI) such as the aforementioned Web browser. As such, a Web browser is an instance of a GUI, and can include capability for World Wide Web navigation, E-Commerce or Enhanced TV applications, etc. For simplicity of explanation, in this description the terms GUI, Web browser and browser are used interchangeably.

An encapsulation mechanism using Web and Internet protocols is utilized to enable user control of a device via the GUI in another device. As such, in one case, a service device passes its control interface data to the renderer for presentation to the user on the GUI of the renderer, whereby the user can control that service device. A top level controller server that orchestrates a top level GUI is defined, while lower levels are solely presented by the renderer.

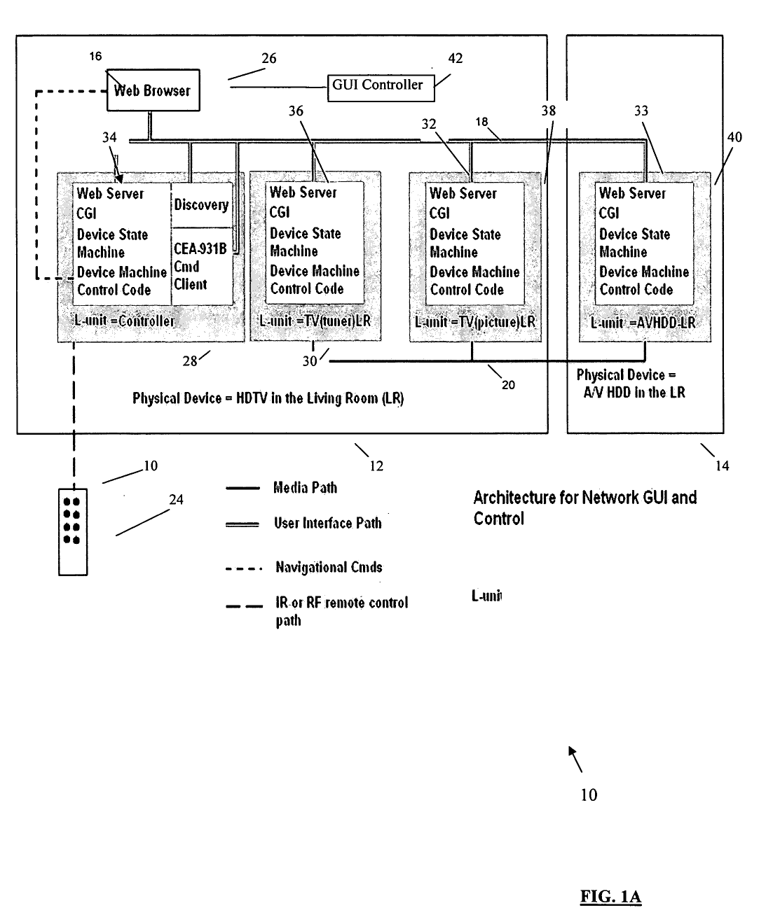

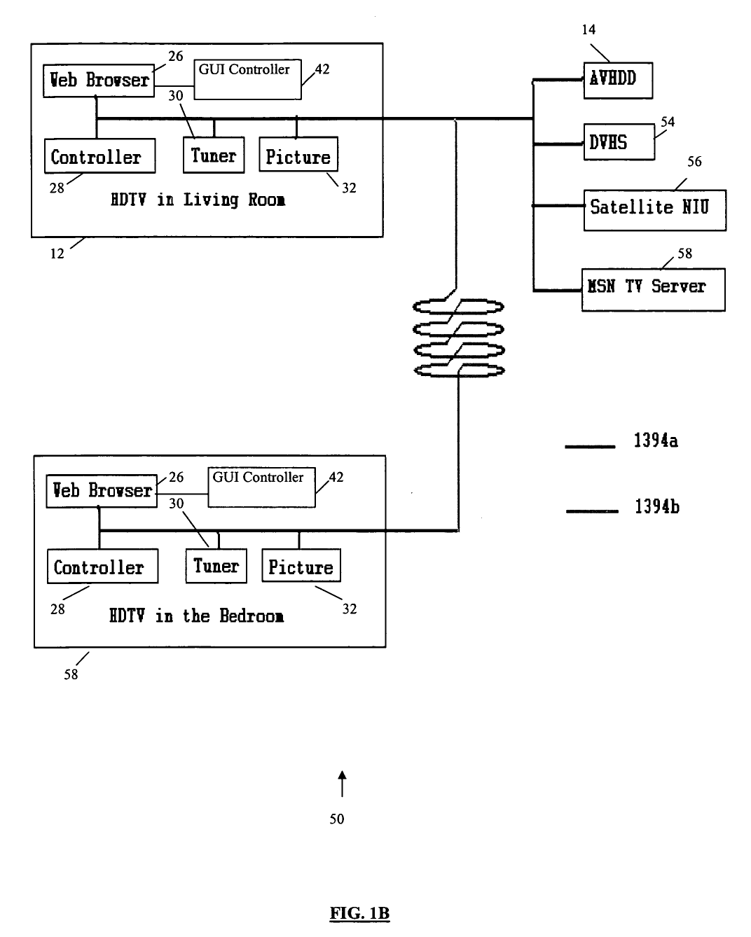

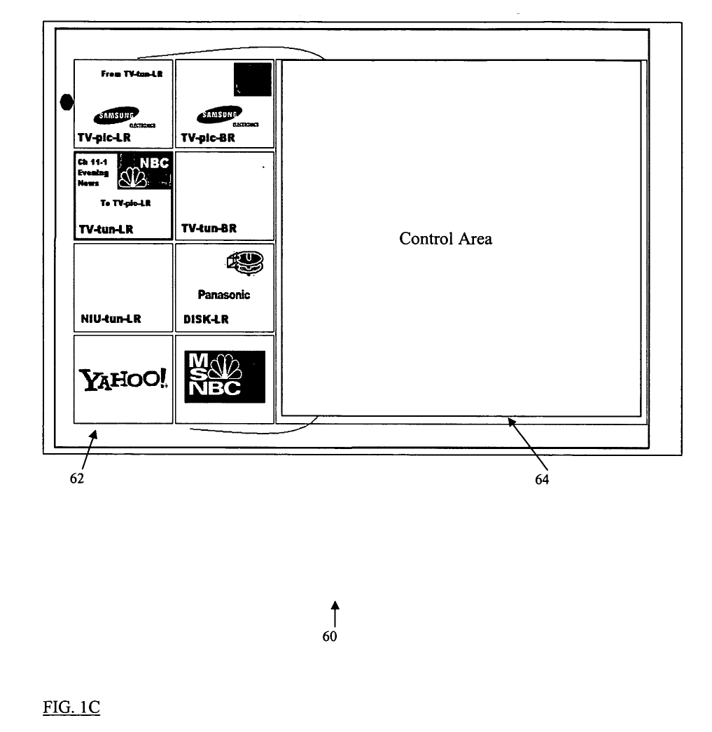

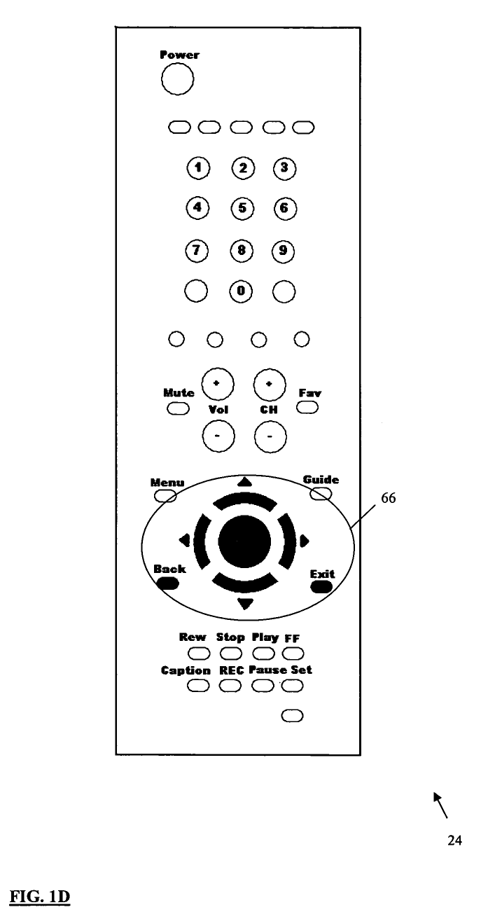

FIG. 1A shows an example functional block diagram of a control architecture of network 10 that implements a user interface according to an embodiment of the present invention. This example is for a GUI and remote control architecture, including two physical devices: an HDTV device 12 and an AVHDD device 14. FIG. 1A further shows communication paths including navigational command paths 16, user interface paths 18, media paths 20 and remote control paths 22 for an infrared or radio frequency remote control device 24.

The HDTV 12 includes a Web browser 26 for presentation and three logical units (L-Unit) as follows: (1) a controller (L-Unit Controller) 28 that includes a GUI controller to dispatch GUI control, (2) a TV tuner and EPG/PSIP server (L-Unit TV(tuner)LR) 30, and (3) a TV decoder (L-Unit TV(picture)LR) 32 for picture and audio. The AVHDD 14 included one logical unit (L-Unit AVHDD-LR) 33 with a recorder and a content player function. The HDTV 12 further includes three Web servers 34, 36 and 38, corresponding to the service functions of said three logical units therein, wherein the Web servers can be incarnations of a single Web server in the HDTV). Further, the AVHDD 14 includes a Web server 40 for its service function.

A logical unit may only be a sub-unit of a physical device, and presents a 5 separately controllable set of functions (e.g., a logical unit refers to a virtual subunit). In this example, there are five types of logical units: (1) media sink, (2) media source, (3) media sink and source, and (4) neither media sink nor media source, and (5) not visible. For example, a website is a type 4 device. A controller device (i.e., client device) is generally paired with a Web browser and ignores all other controller devices. A controller logical unit is not visible and is a type 5 device. The tuner in the HDTV is a type 2 device. A display device is a type 1 device. The AVHDD logical unit is a type 3 device.

Based on the five device types above, the following apply to presenting a GUI for home network (HN) control for the example embodiment described herein.
1. The user interface architecture is provided on the HTTP/TCP/IP networking layer, within a Client Server model and data exchanges of XML data above the IP layer. No direct communication with the underlying network layer is required.
2. In the controller device (e.g., HDTV), a top level GUI controller is utilized and supplies the top level frameset to the controller device Web browser therein. The GUI controller provides orchestration of control between the separate websites provided by the networked devices. Further, the top level GUI controller allows the user to apply control over desired connections between the networked devices. This orchestration provides input to the networked devices to allow them to make the requested connections. Networking control and management is used for the media connections. Further, in a home network, because there can be multiple controller devices, there are multiple Common Gateway Interface (CGI) controllers active simultaneously. CGI is a standard interface for Web Servers that allows programmable side effects of the users selection of hyperlinks. Any CGI controller can control all devices in the home network. An external controller in a STB can present a top level frameset to the GUI controller Web browser.
3. A connection manager is used in the underlying network, wherein direct communication with the connection manager is not necessary except for communication with the networked devices.
4. For each GUI controller, a browser is used to render GUI XHTML content (e.g., control interface, status, etc.) from the networked devices (e.g., service devices, etc.).
5. A Push methodology (described further below) is used to provide a dynamic and current display content.
7. Additional information gathering and dissemination is accomplished via HTTP type commands between the GUI controllers and other connected devices. This allows the GUI controllers to be implemented independent of the underlying home network technology.
8. The look and feel of the top level GUI controller is preserved at the top level. Further, the look and feel of the connected devices are preserved at their level. At the top level, different parts of a GUI may be supplied in near real time and from many connected devices of different brand origin.
9. Each logical unit supports a status frame. The status frame includes the XHTML contents that represents the current status of the device. The frame should be refreshed whenever state changes occur in the device. The frame can further include logo depicting brand and device type.
10. For each discovered logical unit, the GUI controller may support a name frame that displays the unique name of the device and allows for frameset navigation at the top level.
11. Each discovered logical unit can support a control frame, wherein the control frame in the XHTML context represents the top level control interface for that device in addition to optional detailed status text and graphics.

When the network 10 is first powered on, a discovery process is performed to determine the connected physical devices 12, 14 and logical devices (logical units) 28, 30, 32 and 33. Then, the representations for the discovered devices appear on the web browser 26 of the HDTV 12 to receive user control commands, where an initial default context for the networked devices is shown to the user. As the user navigates to, and selects, a sink device such at the AVHDD 14 using the web browser 26, a GUI controller 42 in the HDTV 12 keeps track of that last sink device (e.g., AVHDD 14) that the user selected. Then when the user selects a source device (e.g., L-Unit TV(tuner) LR 30), the GUI controller 42 provides the user's prior selection of the sink device to that source device, without asking the user to specify a sink device for that source device. As such, the source device connects, and sends information, to the sink device specified by the last user-visited link in the browser of the client device. The last visited sink device (e.g., AVHDD 14) becomes the default sink device for other source devices selected thereafter, until the user changes that by navigating to another sink device (e.g., L-Unit TV (picture)LR 32).

Another example network 50 implementing a user interface system according to another embodiment of the present invention is shown as a functional block diagram in FIG. 1B. The network 50 in FIG. 1B includes the functionality and example components 12, 14 of the network 10 of FIG. 1A described above. The example network 50 of FIG. 1B includes six physical devices: (1) the HDTV 12 in the living room (LR), (2) the AVHDD 14, (3) a DVHS 52, (4) a Satellite Network Interface Unit (NIU) 54, (5) an MSN TV Server 56, and (6) another HDTV 58 in the bedroom (BR). In this example, a control page for the top level GUI controller 42 one the HDTVs (e.g., HDTV 12) is described, wherein the GUIs below that level belong entirely to the connected devices. For example, the Satellite NIU 54 has its own full screen EPG function that is the look and feel of the satellite service, and is rendered on the web browser 26 of the GUI controller 42 in XHTML, such that the web browser 26 is used as a network resource for graphical presentation to the user.

FIG. 1C shows an example control page (home page) 60 displayed by the browser 26 under the control of the GUI controller 42 in the HDTV 12 of FIG. 1B. The control page 60 includes status frames (blocks) 62 on the left side of the figure for each discovered device that display Status Icons, wherein each Status Icon shows, e.g., device name, logo, status, etc. In this example, if there are more devices than eight devices in the network 50, then the entire stack of status frames 62 scrolls up/down as the user navigates (navigation is discussed further below). Each status frame 62 generally refers to a device or subunit (logical unit) of a device in the network 50, or to a virtual device such as a Web portal. The web server 40 (FIG. 1A) in each network device provides the status frame 62 and its linked control interface frame for that device to the GUI controller 42 for display on the control page 60. The control interface frame includes the control interface for controlling a device and is described by example further below. For example, the HDTV 12 includes two subunits (i.e., the tuner 30 and the display screen and audio presentation 32), wherein the web server 40 in each subunit provides the status frame and the control frame for that subunit to the GUI controller 42. Each status frame may further include instantaneous device status, a generic icon, a logo, a name and a location, etc.

When a device is connected to the network 50, its status frame 62 is added to the control page 60. When a device is disconnected, its status frame 62 is removed from the control page 60. During the discovery process, the control page 60 is displayed automatically for a specified duration until exited by the user. A device status presentation can change using e.g. a color highlight scheme to indicate that the device is selectable. In one example, when the device icon is color highlighted (e.g., green), and its status frame 62 on the control page 60 is selected by the user, that device obtain system focus. In the drawings, a highlighted status frame is shown with a dark inner border and pointed by an arrow with the reference 62.

A control frame area (Control Area) 64 in the control page 60 is associated with the device that has the system focus, and the control frame for that device is displayed in the control frame area 64 on the control page 60. In the example of FIG. 1C, the AVHDD 14 in the living room is highlighted to indicate that it is selectable, and if the user selects the AVHDD 14, then that device obtains the focus such that its control frame appears in the control area 64 of the control page 60 in FIG. 1C.

The following are example commands issued by the GUI controller 42 to a connected device:
1. Get Media Type (e.g., MPEG2, JPEG, etc.)
2. Get Device Type: Returns DType=(Source_only|Sink_only|Either|Neither ).
3. Get Device Name: Returns a six character Name for the device that is unique across the network, i.e., DName=“abcdef”.
4. Get ICON graphic.
5. Get Status Frame.
6. Get Control Frame.
7. Get Service Banner.
8. Get Open function status: Returns Status=(Open|OK), and Type=(Record|None).
9. Set Possible Connection Target: The controller 42 sends the unique six character name to the, Source or Either, device upon selection of the source device's status frame.

An example network according to an embodiment of the present invention includes the following example configuration:
1. Each physical device can include none, or one or more, client web browsers 26 and one or more logical units with web servers.
2. A controller server 24 comprises a logical unit that presents the top level frameset to one or more client web browsers 26. All other logical units are designated as service devices. The top level controller 24 has access to the results of IP address discovery of the underlying network.
3. Each client web browser 26 is associated with a controller server 24. The web browser 26 is compliant with XHTML 1.0, JavaScript 1.3, DOM 1, and CSS 0. The web browser 26 supports PNG, GIF, and JPEG graphics. The HTTP timeout is set to a period greater than 119 seconds.
4. Each service device communicates its GUI information (e.g., control interface) via HTTP/TCP/IP. GUI information includes XHTML for presentation. Each service device presents its status frame and control frame contents when requested.
5. Each service device responds to commands (e.g., some CEA-931B commands) for quick access control that is a result of the user pressing e.g. remote control keys directed to the device within the current focal context of the controller 28.
6. Service devices respond to HTTP formatted commands (L-unit is <IPaddr>: port), such as:
   a. <L-unit>/status_frame?width=“187”?height=“69”. This command returns the status frame XHTML content to the controllers frameset. Size is suggested by the controller 28 (i.e., GUI controller 42).
   b. <L-unit>/command_frame?width=“430”?height=“460”. This command returns the command frame XHTML content to the requesting control frame within the controller's frameset. Size is suggested by the controller 28.
   c. <L-unit>/service_banner. This command returns a channel banner in XHTML format to the controller's frameset.
   d. <L-unit>/icon_graphic?width=“60”?height=“69”. This command returns a bitmapped icon for the device to the requester. Size is suggested by the controller 28.
   e. <IPaddr>/2027_file. This command returns one XML formatted file describing all device supported logical units in the form: <xml> <NLU>{N the number of logical units} </NLU><LU1><PortNo>port</PortNo><DeviceName>{upto 15char_unique_name }</DeviceName><DeviceType>{ SourceOnly|SinkOnly|Either|Neither|NotVisible} </ADeviceType><CEA931cmds>n, cmd1, . . . cmdn</CEA931cmds></LU1><LU2> . . . </LU2> . . . <LUN> . . . </LUN></xml>
   f. <L-unit>/status_return. This command returns one of the following XML formatted answers:
      i. <xml><StatusReturn> OK </StatusReturn></xml>
      ii. <xml><StatusReturn> Record_Open </StatusReturn></xml>
   g. <L-unit>/connection_target?<unique_name>?<ipaddr:pno>. This command is sent to the possible source device as the sink device suggested to be the connection target of a possible source selection.

In one example, all controllers 28 have a built-in list of networked devices base URL prefix, wherein the URL prefix identifies the HTTP server within the device. An HDTV may have a tuner server and a decoder server, but has only one IP address. In the example embodiment describe herein, the networked device performs discovery of all other connected devices and the system resolves any IP address conflicts.

An example operation scenario when the network is initially turned on is follows:
Power On
Device Discovery
   Initial control page 60 is displayed on the HDTV 12 in the living room
   On the control page 60:
      Two status frames are shown on the control page 60, one for the TV-pic-LR device and one for the TV-tun-LR device
   Connecting the HDTV 58 in the bed room to the network:
      Two more status frames are shown on the control page 60, one for the TV-pic-BR device and one for the TV-tun-BR device
   Connecting NIU&HDD 56, AVHDD 14 and DVHS 54 to the network:
      Three more status frames are shown on the control page 60, one for the NIU-tun-LR device, one for the DISK-LR device and one for the DVHS device
Control of Networked Devices:
   The HDTV 58 in the bed room is controlled from the HDTV 12 in the living room
Selecting a source device and recording on a sink device in the network, without disturbing the video being watched on any display device (e.g., display device 32 on the HDTV 58), such as:
   TV-tun-BR source selection and recording on DISK-LR
   NIU-tun-LR source selection and recording on the DVHS
Watching another channel on TV-pic-LR, without disturbing any recording
Transferring programs from DISK-LR to DVHS, without disturbing the programs being watched throughout the home
   Canceling recording on the DVHS and rewinding
   Backing up a program on DISK-LR to D-VHS
   Deleting the program from DISK-LR
Browsing a web portal
   Viewing MSNTV station service and browsing on TV-pic-LR

Many other example operations of the network are possible.

An example navigation and control process from the HDTV 12 in FIG. 1B is now described. Basic navigation on the HDTV 12 is performed using e.g. five navigation keys 66 on the remote control 24 (FIG. 1CD) that allows a user to interact with the GUI controller 42 that browser 26 of the HDTV 12. The navigation keys 66 include: UP (▴), DOWN (▾) LEFT ( [symbol] ), RIGHT ( [symbol] ), and SELECT (←), as shown in FIG. 1CD. Additionally, a BACK key navigates by returning to the last object highlighted, and an EXIT key allows the entire control and status frameset to be cleared and lets the user watch video on the HDTV screen. The EXIT key also functions as a HOME key, in that, it revives the top level frameset if pressed when clear video is showing.

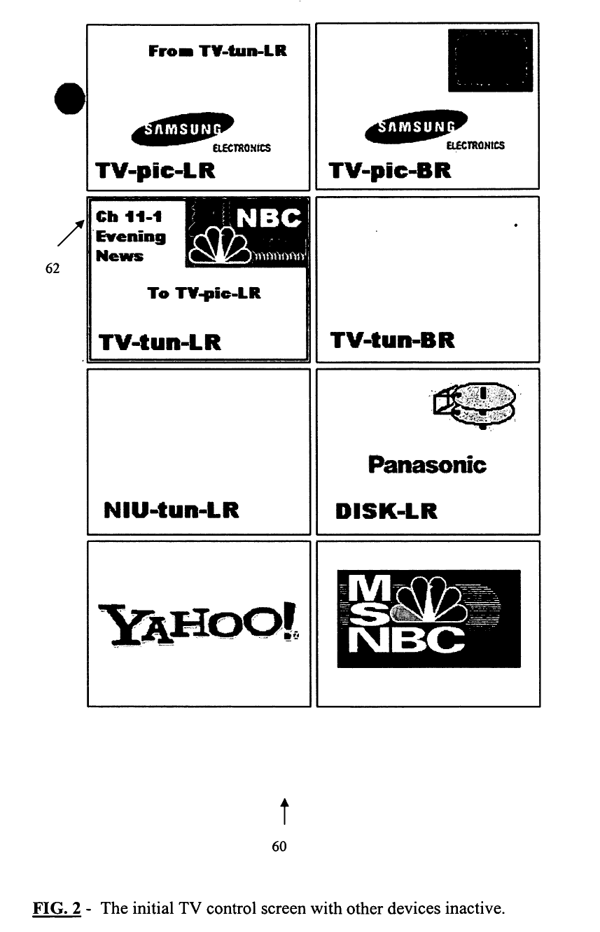

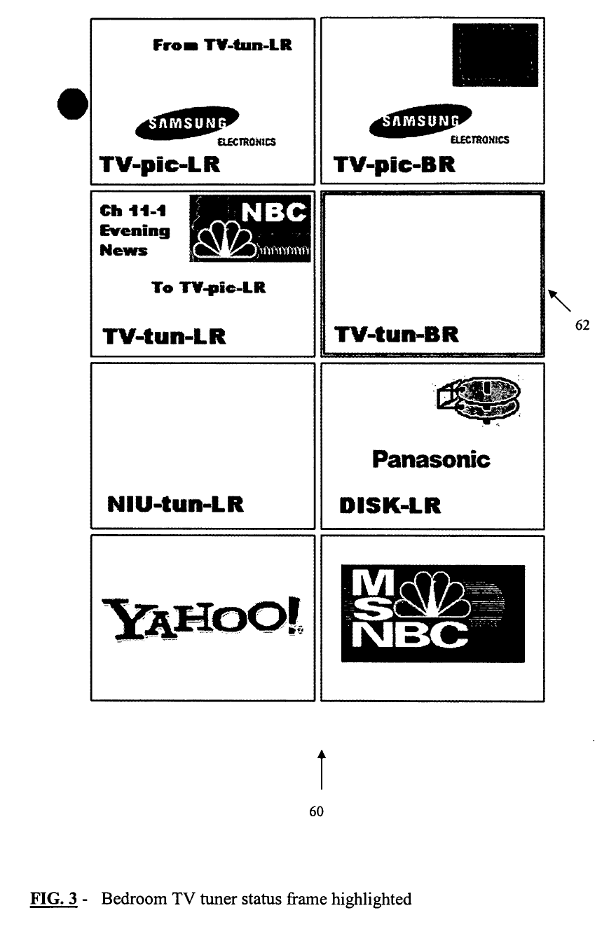

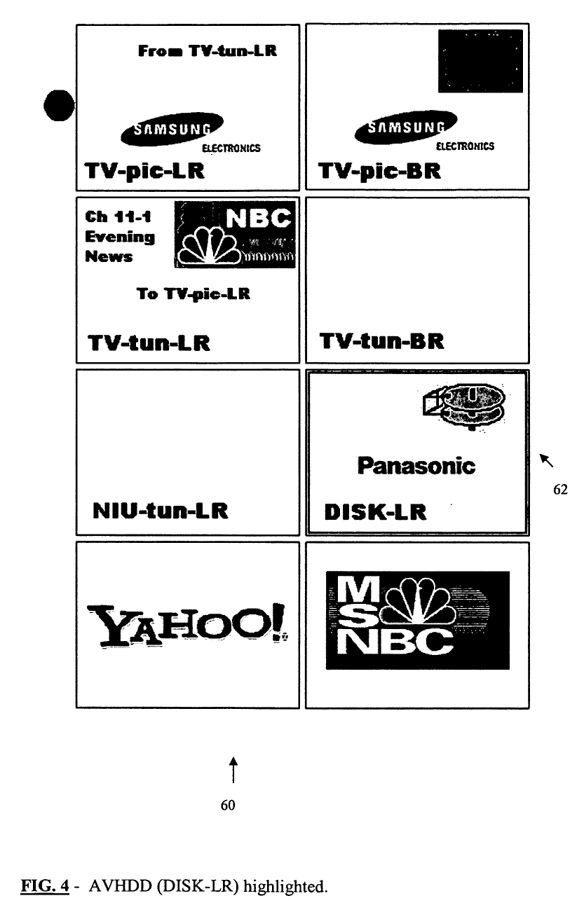

In one case, when the HDTV 12 is powered up the control page 12 is as shown in FIG. 1C. When EXIT is pressed on the remote 24, the display changes to the example in FIG. 2, showing representations of the discovered devices in the network in status frames 62. The same result would occur if the user presses the Power button on the remote control 24. A highlighted status frame 62 indicates that the corresponding device is selectable. The navigation keys 66 can be used to select (highlight) other status frames on the control page 60. Using UP, DOWN, LEFT, and RIGH keys, moves the highlight from one status frame 62 to another. However, no control of the networked devices represented by status frames 62 is exercised until the SELECT button is selected by the user. For example, if the RIGHT button is pressed, the control screen 60 changes to that shown in FIG. 3 wherein the adjacent status frame to the right is highlighted. From system status in FIG. 3, if the DOWN button is pressed, the control screen 60 changes to that shown in FIG. 4 wherein the adjacent status frame below is selected.

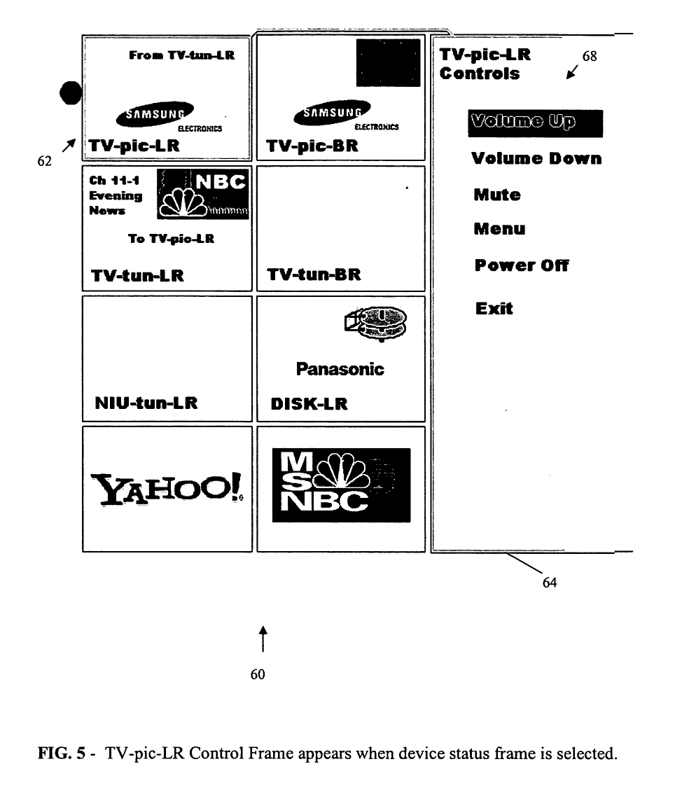

Further, from the screen 60 in FIG. 2, if the user presses UP the status frame 62 of the logical unit TV-pic-LR 32 in the HDTV 12 is highlighted. If the user then presses SELECT when the status frame 62 of the TV-pic-LR 32 is highlighted, the screen 60 changes to that in FIG. 5, wherein the control frame 68 for the selected device TV-pic-LR 32 is shown in the control area 64 of the control page 60. The control frame information and layout is provided by the web server 38 in the selected device TV-pic-LR 32.

If when the TV-pic-LR 32 is selected, the device is in the power off state, then a power on command is sent to the device 32. As the tuner 30 is built into the HDTV 12, the tuner 30 also changes state to powered on. The tuner 30 then tunes the last tuned channel that it tuned just before it was powered off, and the TV-pic-LR device 32 decodes and displays that transport stream from the tuner 30. As such, the TV-pic-LR device 32 goes from a black screen to a picture as the icon in FIG. 5 shows, and the status frame 62 for the TV-pic-LR device 32 is highlighted (e.g., in yellow) to indicate control focus for that device 32. As mentioned, the control frame 68 for the TV-pic-LR device 32 appears in the control area 64 showing the device controls with “Volume Up” highlighted. Because the tuner 30 was also powered up with the TV-pic-LR device 32, the status frame of the tuner 30 (TV-tun-LR) is also shown on the screen 60 in FIG. 5 with the channel logo and channel name and number, wherein the program name appears in the status frame of the TV-tun-LR device.

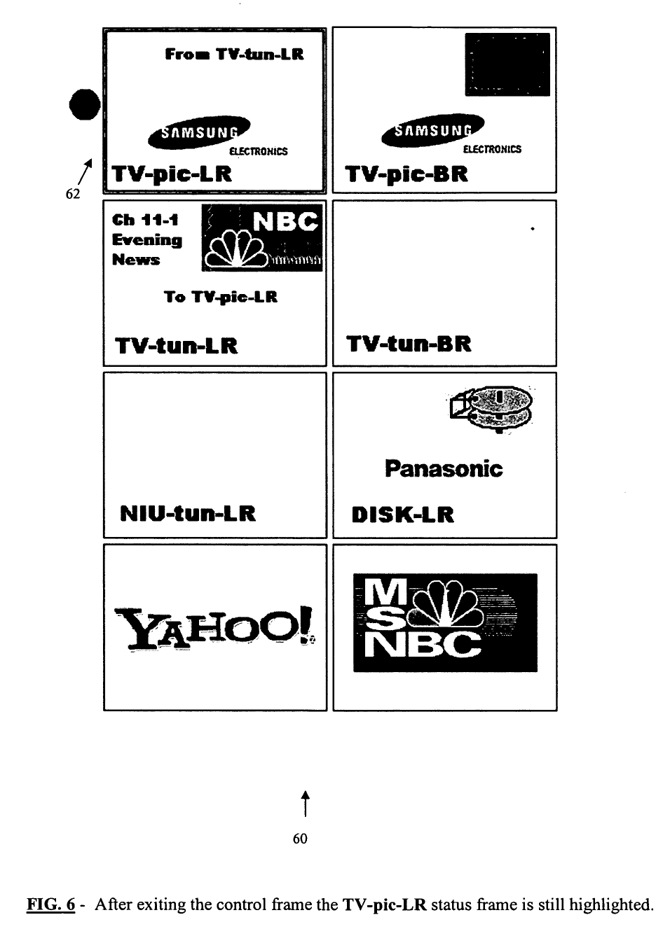

From the network state shown in FIG. 5, if the DOWN button is pressed on the remote control 24, then the “Volume Down” button in the control frame area 64 will be highlighted. Another press on the DOWN button will highlight the “Mute” function. If the status frame of the TV-pic-LR 32 is highlighted, and the controls 68 are shown as in FIG. 5, then a SELECT will Mute the device TV-pic-LR 32. Navigating DOWN to the “EXIT” function and pressing SELECT will exit the control frame 68 and return to the highlighted status frame of TV-pic-LR 32 as shown in FIG. 6.

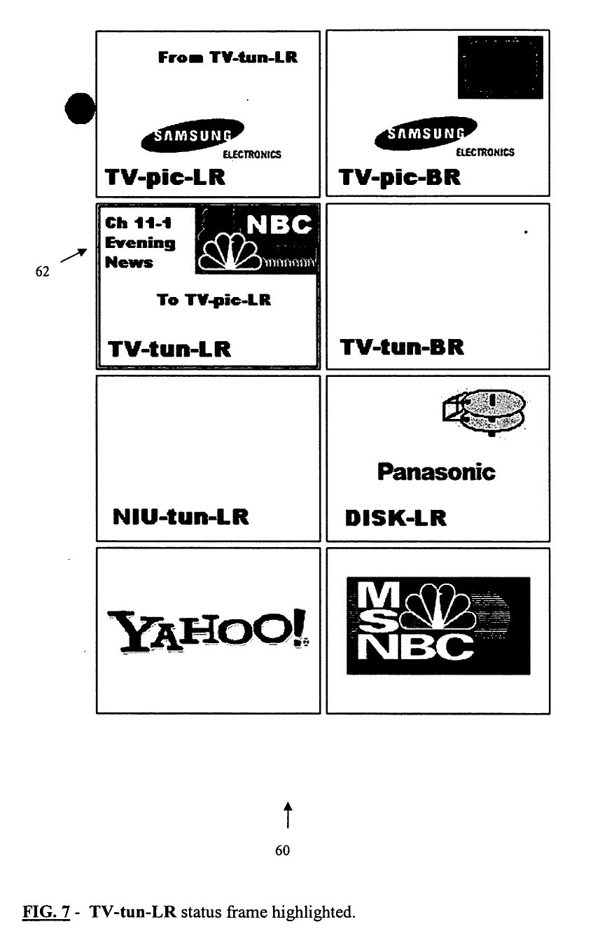

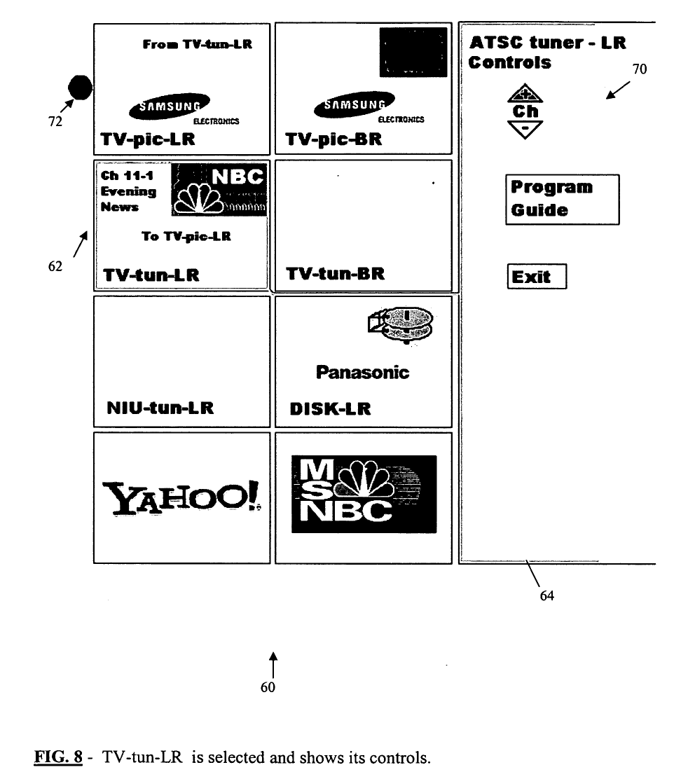

If the status of the network is as shown in FIG. 6, and DOWN is pressed, then the screen 60 changes to that shown in FIG. 7 with the status frame 62 for the tuner TV-tun-LR 30 highlighted. From the state indicated in FIG. 6, if SELECT is pressed, then as shown in FIG. 7, then the status frame 62 for the tuner TV-tun-LR 30 is highlighted and the control interface 70 for the tuner TV-tun-LR 30 is shown in the control area 64 of the control page 60 as in FIG. 8.

According to another aspect of a user interface system according to an embodiment of the present invention, a “target” symbol 72 indicates corresponds to a device that is in focus and will be the target of any subsequent e.g. source device selection until another target device is selected. In the example in FIG. 8, the target device is the video sink device TV-pic-LR 32 to which all subsequent source selections will be connected. The target symbol 72 acts as a bookmark, and appears proximate the status frame of the TV-pic-LR 32. If the network status is as depicted in FIG. 8 and the DIR function is selected from the control frame 64 of the TV-tun-LR 30, then a list of programs stored on that device appears on the screen. If a program is selected from the list and played, then the program will be shown on the device that has the target symbol 72 at the time. In this case, the TV-pic-LR 32 will decode and show the program selection from the tuner TV-tun-LR 30.

Whenever the target symbol 72 is used, it is placed by the GUI controller 42 on the control page 60 proximate the status frame of the device that the GUI controller 42 is indicating as the target. In the case of a video presentation device which has the target symbol 72, and has only one main video display screen (as in the case of most all HDTVs today), the display will show each subsequent source selection as the sources are selected.

In general, no change occurs to the service connection of any sink device that is not the target. There is only one target symbol on the control page 60. When a new device frame obtains the target symbol 72, then the target symbol 72 disappears from its previous position on the screen 60. As with the highlights on the control page 60 that are determined by the GUI controller 42, the target symbol 72 is a GUI controller relative indicator. Each GUI controller 42 operates independently with respect to highlighting and target symbol 72 placement on its corresponding control page 60.

In the following, an example of target symbol placement by the controller 42 as a function of user navigation from one sink device to another sink device is explained. Generally, when a user selects an already highlighted status frame 62 of a sink device, the GUI controller 42 moves the target symbol 72 to the status frame 62 of that sink device. This is not always the case for devices that are ambiguous as to being a sink or a source device (e.g., the AVHDD and the DVHS devices are such devices). When the record function (REC) is pending for one of such ambiguous devices, their status frames receive the target symbol 72 until the source for the recording has been selected and then the target symbol 72 is moved to its previous position. To achieve such a function, the GUI controller 42 provides the top level frameset to its web browser 26. The CGI task in the web server 26 is aware that each device is either: (1) Source-only, (2) Sink-only, (3) Neither Sink nor Source, or (4) Either Sink or Source (“Either-type” ambiguous devices). This information is received at the controller server CGI. When the control frame of the ambiguous device is displayed in the control area 64 and the highlight on its status frame 62 changes back from in-focus highlight, the CGI task queries the device to determine whether an open record command is pending.

When a user moves the highlight around the status frames and presses Select on a device that is a Sink-only device (e.g., the TV-pic-BR), then the device receives the target symbol 72 on its status frame 62 and subsequent source device selections are connected to that device.

The cases for the AVHDD and DVHS may be different because these devices can be a source and/or a sink at any one time. The AVHDD and DVHS are “Either-type” devices and have a special behavior. An HDTV would be such a device if the Screen and Audio Output controls were not separated from the tuner as separate logical status and control units with two logical HTTP servers. In order for such a device to operate, it must clearly identify its status for all Exits in its control interface. For example, if there is a Record function that has been requested by the user, then the GUI controller 42 that controls that device must distinguish the situation that requires an immediate source selection. The GUI controller 42 can then assign the recording device as the immediate target and direct the user to navigate to only source capable devices. This would not be necessary if the AVHDD had two separate servers one for recording and one for playing.

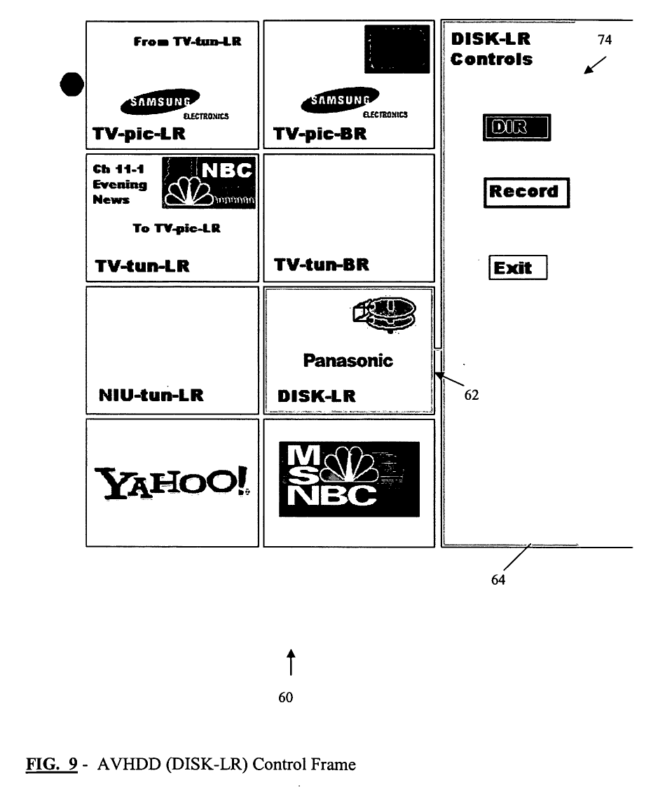

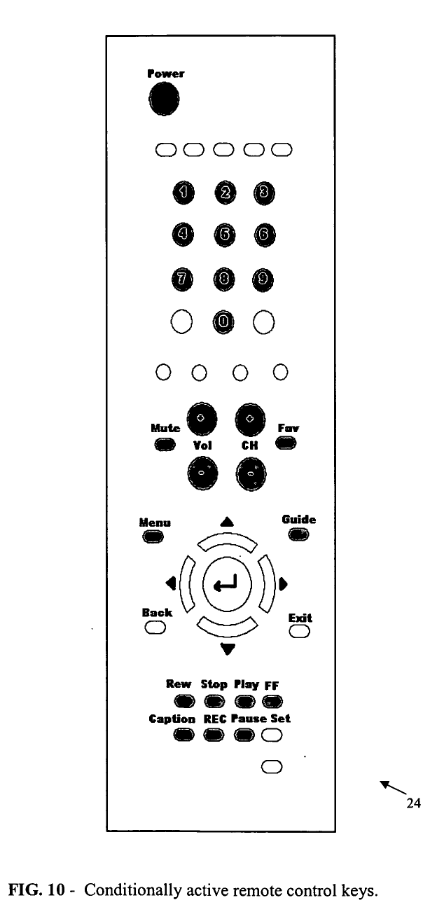

An example of controlling the “Either-type” (ambiguous) devices is now explained. For example, if the network status is as in FIG. 6, wherein the TV-pic-LR 32 is powered on, and its status frame 62 is highlighted, the user navigates to the status frame of the AVHDD 14 that includes the DISK-LR 33, by pressing the RIGHT, DOWN and DOWN buttons on the remote control 24. Then, when the user presses SELECT, the control area 64 displays the control frame/interface 74 of the DISK-LR 33 as shown by example FIG. 9. When SELECT was pressed, the GUI controller 42 also sent the name of the current target device (i.e., TV-pic-LR 32) to the DISK-LR 33. The control frame 74 for the DISK-LR 33 includes both a DIR function and a RECORD function. If the DIR function is selected (the DIR function provides a list of available videos on the storage device), then most probably the DISK-LR 33 acts as a source device and the target device information is used accordingly. The function of the DISK-LR 33 is determined when the user selects a video to be played (user may also possibly return to the DIR--RECORD menu and select RECORD). If the RECORD function is selected, then the control frame 74 for DISK-LR 33 exits, wherein the GUI controller 42 upon issuing a “Get Open Function Status” request, determines that a RECORD function is open and that the DISK-LR 33 should get the target symbol 72 (the device status frame navigation should be restricted to only possible source devices). In this case, the highlighting is moved to the last selected source device (AVHDD=Audio/Video Hard Disk Drive) status frame. When a source device has been selected and connected to the DISK-LR recorder 33, then the GUI controller 42 should reset the target symbol 72 to the device previously holding it, i.e., prior to the RECORD function selection.

When the status frame of a device is highlighted or the device is in focus with one of its control frames displayed on the control page 60, then some of the keys on the remote control 24 may be activated. Examples of such keys (darkened in FIG. 1C0) include: POWER, 0-9, MUTE, CH+/−, VOL+/−, MENU, GUIDE, REW, STOP, PLAY, FF, CAPTION, REC and PAUSE. These keys are conditional because their effect is different under different conditions (conditional refers to the results produced by pressing the key). For example, the POWER key turns off the TV-pic-LR 32 when the user is watching a clear video screen (e.g., watching TV where no On Screen Display “clutters” the screen) on the device 32. However, when the user of TV-pic-LR 32 is viewing the control page 60, and the status frame of the TV-pic-BR (decoder) of the HDTV 58 is highlighted, the TV-pic-BR is on, and the user presses the POWER key, then the TV-pic-BR device is powered off, and its status frame reflects that new state.

As noted above, for effective event notification to the user, in another aspect the present provides a Push method that allows a connected device to send status and notification messages directly to the user, independent of the version of HTTP supported, and for all MIME types. An example Push method for HTTP uses a subframe, which is a one pixel iframe without borders (not visible) that is embedded within the device status frame 62, and initially posted by the web server of the device (e.g., web server 40, FIG. 1A) to the control page 60 via the GUI controller 42. This subframe contains a request to the web server to update, which the web server of the device intentionally leaves unfulfilled for a fixed period of time (e.g., 110 sec.). The web browser of the GUI controller 42 is set to timeout HTTP requests after a certain time period (e.g., 120 sec.). If the device does not have any notification or change of state status message to display to the user during the fixed time period, then at the end of the fixed time period the web server of the device returns the same e.g. Javascript to request an update to the subframe. If during the fixed timer period a change occurs, then the web server of the device immediately sends the update of status message to the parent frame and at the same time reloads the subframe with a new update request. This uses the parent and frames' properties and location method of Javascript 1.2.

While this invention is susceptible of embodiments in many different forms, there are shown in the drawings and will herein be described in detail, preferred embodiments of the invention with the understanding that the present disclosure is to be considered as an exemplification of the principles of the invention and is not intended to limit the broad aspects of the invention to the embodiments illustrated. The aforementioned example architectures, according to the present invention, can be implemented in many ways, such as program instructions for execution by a processor, as logic circuits, as ASIC, as firmware, etc., as is known to those skilled in the art. Therefore, the present invention is not limited to the example embodiments described herein.

The present invention has been described in considerable detail with reference to certain preferred versions thereof; however, other versions are possible. Therefore, the spirit and scope of the appended claims should not be limited to the description of the preferred versions contained herein.

1. A method for providing a user interface in a network including interconnected client and service devices, the user interface for controlling the service devices that are currently connected to the network, comprising the steps of:
(a) obtaining information from one or more of said service devices currently connected to the network, said information including device information;
(b) generating a user interface including status information of said service devices based on said device information;
(c) displaying the user interface on a client device capable of displaying a user interface, for user navigation and control of said service devices;
(d) tracking user navigation and control of said service devices; and
(e) based on the tracking information, providing the user with default service device selection on the user interface.

2. The method of claim 1 wherein the step of providing the user with default service device selection is further based on the service device function.

3. The method of claim 1 wherein the step of providing the user with default service device selection is further based on one of prior service device selections by the user.

4. The method of claim 1 wherein the step of providing the user with default service device selection is further based on the last service device selections by the user.

5. The method of claim 1 wherein the service devices include source devices and sink devices, such that the step of providing the user with a default sink device selection for a source device is further based on one of prior sink device selections by the user.

6. The method of claim 1 wherein the service devices include source devices and sink devices, such that the step of providing the user with a default sink device selection for a source device is further based on the last sink device selection by the user.

7. The method of claim 1 wherein the service devices include source devices and sink devices, such that the step of providing the user with a default source device selection for a sink device is further based on one of prior source device selections by the user.

8. The method of claim 1 wherein the service devices include source devices and sink devices, such that the step of providing the user with a default source device selection for a sink device is further based on the last source device selection by the user.

9. The method of claim 1 wherein the steps of displaying the user interface on said client device further includes the steps of displaying the user interface on a browser in the client device.

10. The method of claim 1 wherein the steps of displaying the user interface on said client device further includes the steps of displaying service device control information.

11. The method of claim 10 wherein the steps of displaying service device control information further includes the steps of displaying service device control information for a service device selected by the user.

12. The method of claim 1 wherein the device information in each service device includes a user interface description for user interaction with that device.

13. A network comprising:
a client device;
services devices interconnected with the client device;
a user interface controller in the client device that provides a user interface for controlling the service devices that are currently connected to the network, by:
(a) obtaining information from one or more of said service devices currently connected to the network, said information including device information;
(b) generating a user interface including status information of said service devices based on said device information;
(c) displaying the user interface on a device capable of displaying a user interface, for user navigation and control of said service devices;
(d) tracking user navigation and control of said service devices; and
(e) based on the tracking information, providing the user with default service device selection on the user interface.

14. The network of claim 13 wherein the controller provides the user with default service device selection further based on the service device function.

15. The network of claim 13 wherein the controller provides the user with default service device selection further based on one of prior service device selections by the user.

16. The network of claim 13 wherein the controller provides the user with default service device selection further based on the last service device selections by the user.

17. The network of claim 13 wherein the service devices include source devices and sink devices, such that the controller provides the user with a default sink device selection for a source device further based on one of prior sink device selections by the user.

18. The network of claim 13 wherein the service devices include source devices and sink devices, such that the controller provides the user with a default sink device selection for a source device further based on the last sink device selection by the user.

19. The network of claim 13 wherein the service devices include source devices and sink devices, such that the controller provides the user with a default source device selection for a sink device further based on one of prior source device selections by the user.

20. The network of claim 13 wherein the service devices include source devices and sink devices, such that the controller provides the user with a default source device selection for a sink device further based on the last source device selection by the user.

21. The network of claim 13 wherein the controller further displays service device control information on the user interface.

22. The network of claim 21 wherein the controller displays the service device control information for a service device selected by the user.

23. The network of claim 13 wherein the device information in each service device includes a user interface description for user interaction with that device.

24. The network of claim 13 wherein the client device further includes a Web browser such that the controller displays the user interface on the browser.

25. The network of claim 24 wherein each service device includes a Web server that provides the device information to the controller.

26. The network of claim 25 wherein the devices communicate via the HTTP network protocol

27. A client device that provides a user interface for controlling service devices currently connected to a network, comprising:
a controller that provides a user interface for controlling the service devices, by:
(a) obtaining information from one or more of said service devices currently connected to the network, said information including device information;
(b) generating a user interface including status information of said service devices based on said device information;
(c) displaying the user interface on a device capable of displaying a user interface, for user navigation and control of said service devices;
(d) tracking user navigation and control of said service devices; and
(e) based on the tracking information, providing the user with default service device selection on the user interface.

28. The client device of claim 27 wherein the controller provides the user with default service device selection further based on the service device function.

29. The client device of claim 27 wherein the controller provides the user with default service device selection further based on one of prior service device selections by the user.

30. The client device of claim 27 wherein the controller provides the user with default service device selection further based on the last service device selections by the user.

31. The client device of claim 27 wherein the service devices include source devices and sink devices, such that the controller provides the user with a default sink device selection for a source device further based on one of prior sink device selections by the user.

32. The client device of claim 27 wherein the service devices include source devices and sink devices, such that the controller provides the user with a default sink device selection for a source device further based on the last sink device selection by the user.

33. The client device of claim 27 wherein the service devices include source devices and sink devices, such that the controller provides the user with a default source device selection for a sink device further based on one of prior source device selections by the user.

34. The client device of claim 27 wherein the service devices include source devices and sink devices, such that the controller provides the user with a default source device selection for a sink device further based on the last source device selection by the user.

35. The client device of claim 27 wherein the controller further displays service device control information on the user interface.

36. The client device of claim 35 wherein the controller displays the service device control information for a service device selected by the user.

37. The client device of claim 27 wherein the device information in each service device includes a user interface description for user interaction with that device.

38. The client device of claim 27 wherein the client device further includes a Web browser such that the controller displays the user interface on the browser.

39. The client device of claim 38 wherein each service device includes a Web server that provides the device information to the controller.
